(19) United States
(12) Patent Application Publication
(10) Pub. No.: US 2024/0086642 A1
(43) Pub. Date: Mar. 14, 2024

(54) User-Focused Sensory and Experiential Content Index and Curation for Social Media Networks and Media Distribution Systems

(71) Applicant: William Michael Seaward, Toronto (CA)

(72) Inventor: William Michael Seaward, Toronto (CA)

(21) Appl. No.: 18/467,719

(22) Filed: Sep. 14, 2023

Related U.S. Application Data
(60) Provisional application No. 63/375,593, filed on Sep. 14, 2022.

(51) Int. Cl. G06F 40/30; G06Q 50/00

(52) U.S. Cl. CPC G06F 40/30; G06Q 50/01

(57) ABSTRACT

A user-centric method for content indexing, curation, and recommendation utilizing content tags that indicate the widest possible range of human psychological states, experience, and life outcomes; and a means of aligning these tags with the dynamically expressed explicit desires and goals of users, input as natural language strings, which are mapped to said tags using a variety of natural language processing techniques, such that expressed desires and goals define preferences applied to content search, filtering, curation, organization, and personalization functions. It also introduces an intuitive user interface for navigating the full gamut of existing content tags and preferences, as well as predictive modeling techniques for better alignment of content with desired user outcomes.

### CROSS-REFERENCE TO RELATED APPLICATIONS

This application claims the priority benefit, under 35 U.S.C. Section 119(e), to U.S. Provisional Application No. 63/375,593, entitled “KNOWLEDGE VERIFICATION ON AN ELECTRONIC COMMUNICATIONS NETWORK FOR THE QUALIFICATION AND VERIFICATION OF CLAIMS, THE PROVISION OF EVIDENCE, AND THE VERIFICATION OF INDIVIDUAL USER KNOWLEDGE UTILIZING EXISTING SOCIAL CONNECTIONS, IN CONJUNCTION WITH THE IMPLEMENTATION OF USER-DEFINED PREFERENCES THAT PERMIT USERS TO FILTER CONTENT RECOMMENDATIONS, ASSOCIATED WITH A CONTENT FEED, ACCORDING TO THE USER'S SELF-DEFINED INTERESTS, MOODS, DESIRES, GOALS, OR PSYCHOLOGICAL STATES,” filed Sep. 14, 2022, which is hereby incorporated by reference in its entirety.

### FIELD OF INVENTION

The present invention relates generally to social media networks and media distribution systems, and more specifically to computer-implemented methods for content indexing, searching, filtering, curation, and recommendation on such systems. The system aims to better align user desires with user experiences on these platforms.

### BACKGROUND OF THE INVENTION

Social media networking systems often use algorithms to manage how content is shared, distributed, curated, and recommended to users. Outside of the social network setting, other digital content publishers and distributors, including stand-alone content aggregators, such as news aggregators, and media platforms, such as music or video distribution platforms, also typically use such algorithms to control the distribution of content (Content shall hereinafter refer collectively to any form of digital communication transmitted on any of these systems, including videos, posts, chats, articles, group chats, individual chats, rooms, feeds, collections of items, and individual user profiles. User shall refer to any person using any such platform).

Users of these services are typically able to view content in a variety of graphical formats. A common format, referred to as a feed, presents content to the user as a dynamic list, or dynamic scrolling menu, containing the individual items of content selected for and delivered to the user. These items may be delivered to the user, in whole or in part, either as the complete content item or as a recommendation of the content to the user. Many variations of feeds exist. The user may be able to sort through multiple feeds or collections and apply search or selection criteria to the content, while nonvisual presentation formats also exist.

Social media systems and stand-alone content aggregators implement a variety of approaches to determining what items of content are selected for presentation to the user from a larger corpus of content. These approaches to content recommendation, curation, organization, or ranking, may involve a combination of user-defined preferences, or any number of algorithmic functions, which determine what the user is either able to, or likely to, access. These activities typically either work by either filtering search results presented to the user or determining automated recommendations of content suggested to the user. The curation operations executed by an algorithm may be informed or controlled by any number of programmed rules or inputs, including user defined preferences, patterns of historical content consumption, or other data associated with the user's activity either inside the same social media system or in other digital media environments. Such inputs are typically also combined with additional rules that are premised on the business objectives of said platforms. These software processes, combined with inputs derived from data associated with users, and other hard-coded rules, comprise the general mechanism of content search, curation, and recommendation, utilized across social media networks and digital media distribution services. Machine-learning algorithms are a particular sort of automated curation that uses software to build a predictive model of user behavior, capable of automatically inferring how the user will respond to different content. And these inferences may also be used in search, curation, and recommendation algorithms (the foregoing process and all of its constituent elements relating either to the manual or software-enabled filtering, ranking, aggregating, curating, or organizing of content on social media networks and digital media distribution services shall hereinafter be collectively referred to as content curation. In general, algorithmic curation, utilizing either a hard-coded approach or a machine learning process is achieved using four types of data inputs: the business objectives of the service; user preferences; explicit user-actioned inputs, such as likes and dislikes or search terms; and implicit user inputs derived from observing and logging human behavior.

Importantly, while user-defined preferences and explicit user inputs offer users direct control over how their content is curated, implicit inputs do not. This means curation outcomes produced by algorithms that rely heavily on a combination of implicit inputs, business objectives, and model predictions may diverge from what users would choose, if they were otherwise given more choice and control of the curation. This mismatch between what users would actually choose to experience and what platforms choose for users to experience may lead to user dissatisfaction and potential harms to users, even if platform revenues appear optimized.

Public concerns have been expressed regarding the ways in which many commonly deployed curation algorithms work, the content selections they make, and their overall effect on users. Meanwhile, approaches to content curation across major social media systems have become increasingly focused on implicit inputs and prediction to control their content curation algorithms, with the primary end goal of optimizing engagement time as a function of revenue optimization.

The reasons why implicit inputs and predictions may produce negative digital content experiences and outcomes for users can ultimately be understood in two broad respects, first, the full range of human desires and interests is broader and more nuanced than existing content curation algorithms appear to appreciate, and second, this curation approach appears to significantly limit a user's ability to reflect on their inner hierarchy of desires and their ability to express and refine these desires through their actual choices.

Implicit inputs derive entirely from the external behavior of users. Content curation algorithms that model user content recommendations on these inputs prioritize the external responses of the user over the subjective experience or psychological state of the user. There is a greatly diminished capacity for the user to report their subjective conscious experiences or desires to the algorithm. The user's explicit conscious experiences, desires, or goals are largely not requested and any opportunity to supply them are greatly limited. Users generally cannot report to existing media platforms how an item of content makes them feel, or to what extent it reflects their goals or ambitions, or what the user wants to represent or who the user wants to be. Yet, it seems likely that such user reports would be important in generating content recommendations that users find satisfying.

Rather than serving the interests of users, the algorithmic curation frameworks commonly deployed across social media networks today are generally designed to optimize engagement time at a cost to other outcomes, including user satisfaction and wellbeing.

Denying users the right to fully express their experience and desires in digital life may be remarkably harmful to people even if they are not explicitly aware of it. Or, if they are indeed dissatisfied, it may be hard to attribute the cause. When a user's digital experience is defined using implicit inputs and predictive modeling it is possible to produce a set of outcomes in which users may simultaneously spend significant time on a platform while deriving considerable displeasure from it. This has been documented in the various leaks associated with social media's negative effect on the mental health of young users.

This predictive modeling of users may have negative outcomes that extend beyond satisfaction and mental health and may extend into the long-term realization of a user's life goals and ambitions. Humans are in a sustained state of acting, collecting feedback from acting, and editing one's actions and attitudes based on outcomes and desires. It is well established that humans experience both first order and second order desires, where second order desires can be thought of as desires about desires. For example, an individual who has a first order desire to smoke cigarettes can also possess a second order desire to quit smoking. The struggle between first order and second order desires in determining a person's behavior, forms a unique dynamic in every individual that is central to defining one's personality and enabling one's choices. It is important to note that while these existing content curation algorithms may be able to predict, to some degree, a user's first order desires, it remains unlikely that they are attuned to a user's second order desires.

Maintaining the ability to adequately identify and act on both first and second order desires is fundamental to preserving the identity and self-determination of any individual. Therefore, if content curation algorithms predict and decide for users what they want to experience, or what they will want to experience in the future, without the user's input, these algorithms hinder a user's ability to observe their choices, pursue their deepest desires, and realize their true selves. With this understanding it can hardly be surprising that many users report being dissatisfied with their experiences on social media platforms. For many social media users what effectively results is a feedback loop, where previous choices make similar future choices more likely, causing a user's potential recommendations and experiences to regress to an increasingly narrow landscape.

These sorts of algorithms also likely constrain market competition and market freedom. A market in which participants cannot supply signals regarding their subjective experience back to the market, is not a free market. Rather, it is a highly constrained market, in which the feedback loop noted also begins to define the collective landscape.

Fundamentally, the prevailing social media curation paradigm denies user's not only the ability to define and express themselves with the full depth and variety of art, culture, and communication but also acts to constrain our self-determination.

The current invention helps correct for these problems and improve the digital experiences and wellbeing of online users by providing a media curation approach that delivers three novel improvements: an index and preference engine mapped to the full depth and variety of experiential and sensory attributes of content, a means of giving user's explicit expression and choice over what they pursue and experience, and a recommendation inference system that optimizes for user satisfaction instead of engagement time.

### SUMMARY OF THE INVENTION

The patent application presents a user-focused method for content indexing, curation, and recommendation within social media networks and media distribution systems. The system allows for the tagging of content with a wide range of experiential and sensory descriptors, including but not limited to mood, tone, emotional and psychological impact, pragmatic aspects such as the presence of irony, intent, and aesthetic attributes. These tags, which may or may not be user generated, are mapped to user preferences expressed in natural language, achieved through a variety of natural language processing techniques, enabling content actions like searching, filtering, curation, organization, and recommendation based on matching said user-defined preferences with a wide variety of tags. Natural language processing modules semantically map these preferences to tags, ensuring that content recommendations align with the desires of users. Additionally, the system incorporates a predictive model that leverages the content descriptors to associate and predict human outcomes associated with experiencing the content, including behavioral, emotional, cognitive, and wellness outcomes, to enhance the alignment of user preferences with content tags over time.

The system also introduces a graphical user interface that enables users to easily and intuitively explore the widest possible range of existing tags and preferences. The system also introduces customizable multimedia elements, such as images, graphics, symbols, or sounds, to represent tags and preferences. Users can curate collections of multimedia elements associated with tags or preferences, enhancing the creative and visual aspects of content labeling and personalization.

### BRIEF DESCRIPTION OF DRAWINGS

FIG. 1: Depicts the Tagging Module 100 and its associated components, focusing on the processes for content tagging and indexing.

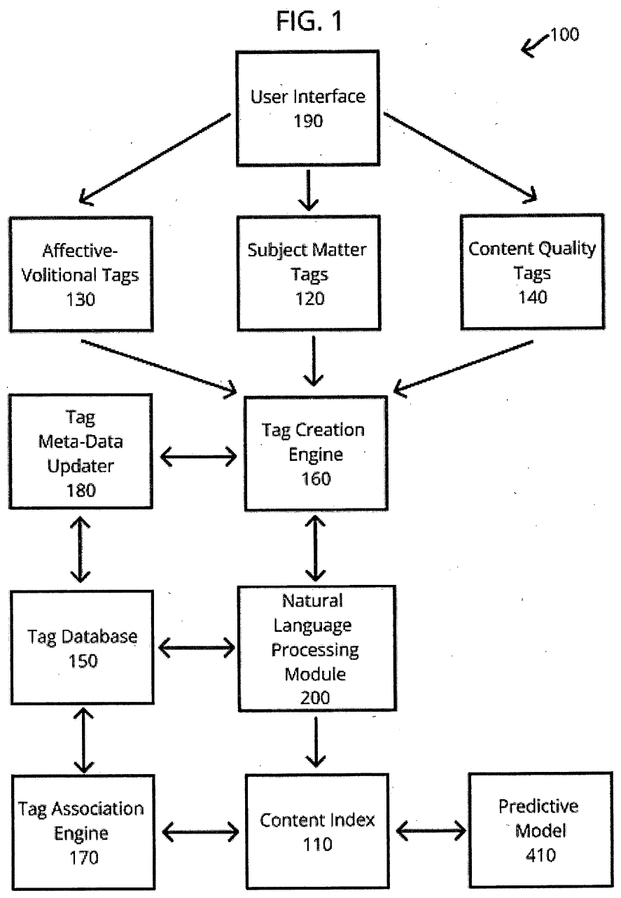

FIG. 2: Illustrates the Natural Language Processing (NLP) Module 200 and its role in semantic mapping of tags and user preferences.

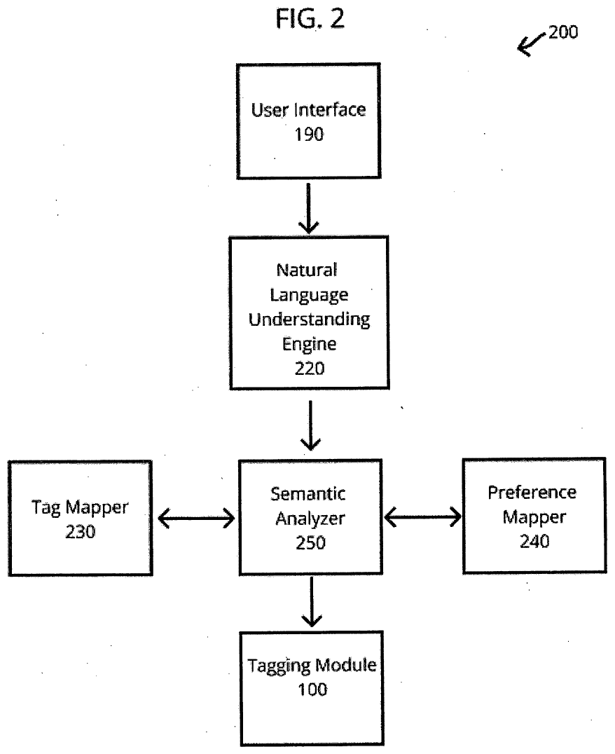

FIG. 3: Illustrates the User Preferences Module 300 and how it captures and interprets user preferences through natural language inputs.

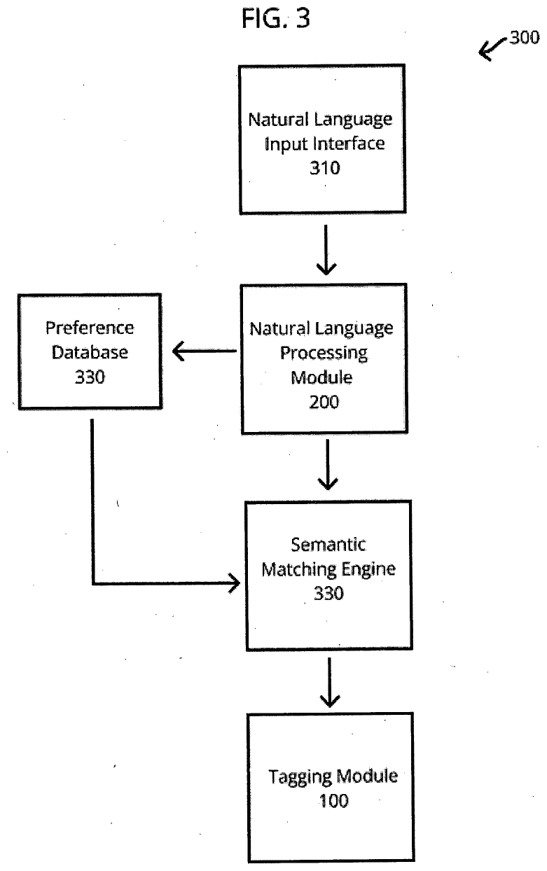

FIG. 4: Represents the Predictive Model and Related Components 400 used to anticipate the impact of content on users based on tags and preferences.

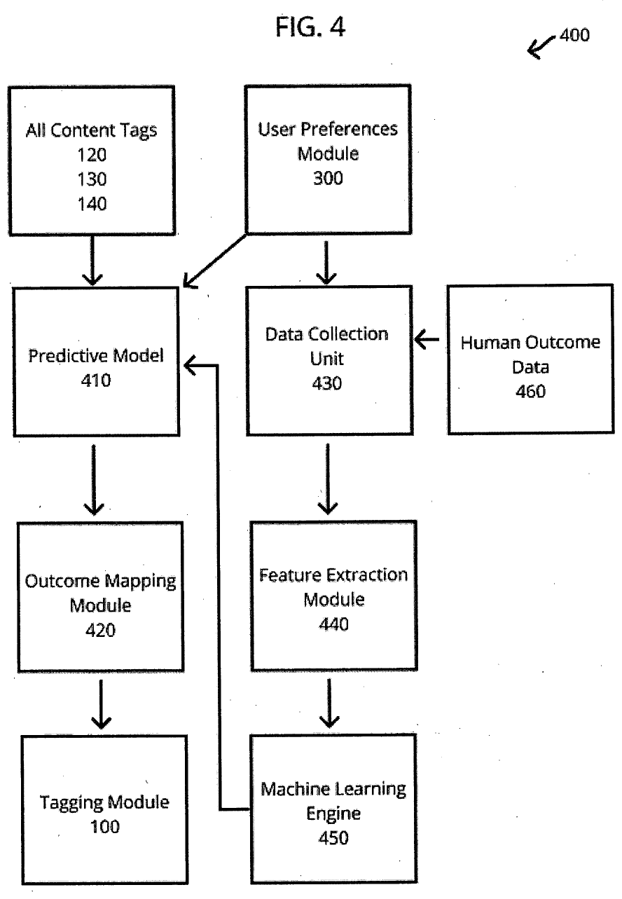

FIG. 5: Illustrates the Multidimensional Vector Space Graphical User Interface (GUI) and its components 500 for visual representation of and interactive engagement with tags and user preferences.

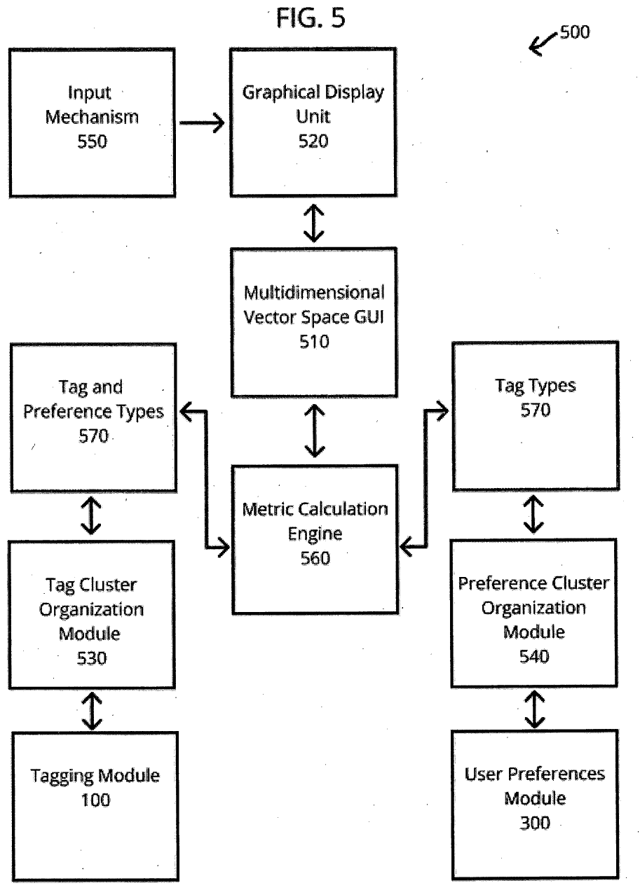

FIG. 6: Depicts the Multimedia Elements and Customization components, outlining how multimedia elements can be customized and associated with tags and preferences.

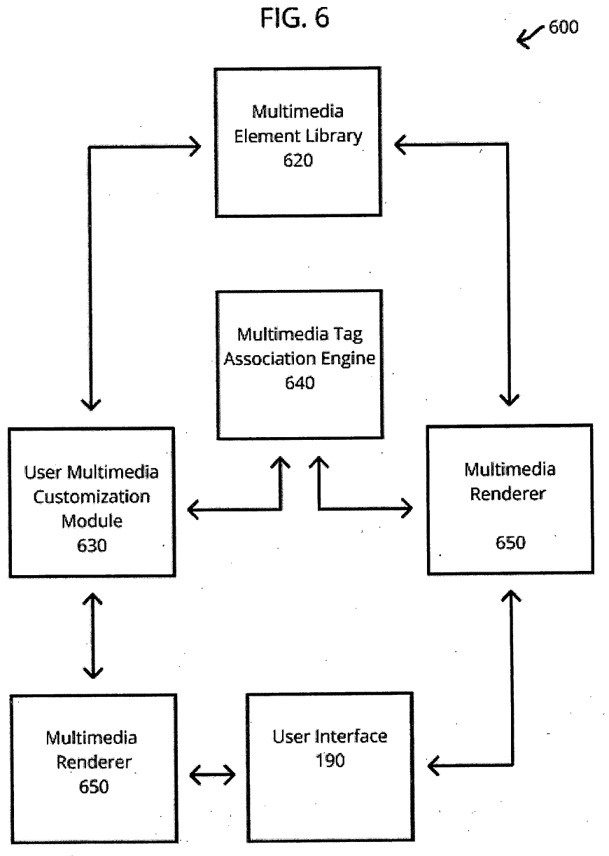

FIG. 7. Illustrates an example of the Multidimensional Vector Space Graphical User Interface (GUI) in a radial presentation 700.

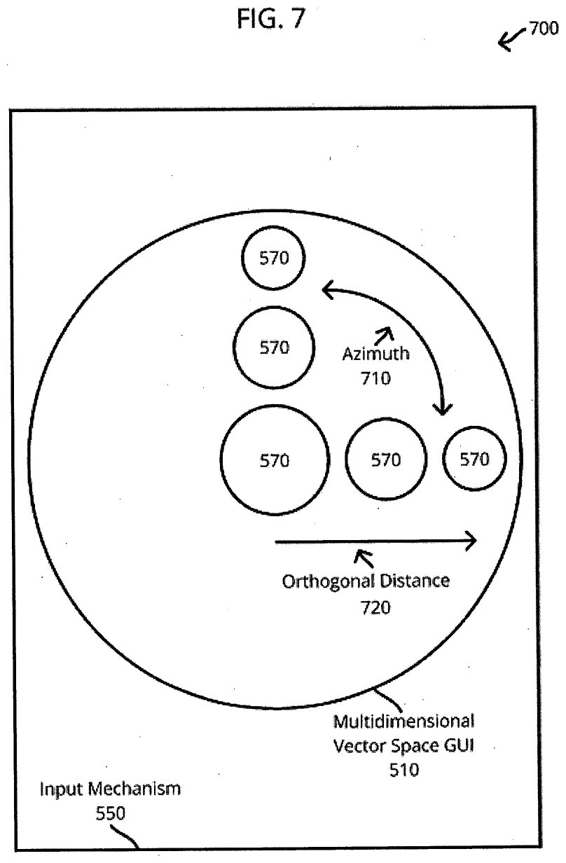

### DETAILED DESCRIPTION OF THE INVENTION

The focus of the described embodiment of the invention is that of a social media network or any digital media distribution service, generally consisting of:

a user interface (UI): allowing users to interact with the system, typically comprising buttons, text fields, and display areas, backend servers: that process and store data, execute algorithms for various functionalities like search, filtering, etc., databases: storing user profiles, content, and other relevant data, and APIs: facilitating communication between the front-end UI, backend servers, and databases.

While social media networks and dedicated media distribution services can be thought of as different types of systems, they share these same four primary elements, and the novel features of the invention apply to any system, on which content of any kind is discovered and accessed by users, whether such a system is chiefly designed to be a media distribution service or a social network service. The following invention and its functional descriptions can be understood as applying to both kinds of systems.

The Tagging Module 100 and associated Content Index 110 sets the foundation for aligning content, and digital experiences in general with what users desire to experience and what outcomes they want to achieve. To enable users to find the content experiences they desire it is necessary to provide a means of labeling and indexing content that captures the widest possible range of attributes that a human user may for whatever reason desire to experience. Content labeling or tagging which facilitates an index 110 can be broken down at the highest level into three broad groups: subject matter tags 120, affective-volitional tags 130, and content quality tags 140.

The first group, subject matter tags 120, pertains to any topic or field of interest associated with the content. The practice of labeling and indexing content across this group is widely explored in prior art and deployed across social networks and media distribution services. Although the present invention can be configured to utilize subject matter tags, and in most practical embodiments the invention would utilize such tags, subject matter indexing is not part of the primary novelty described here. The present invention generally assumes that subject matter is already deployed as part of an index, and that the novel indexing functions described here create a means of aligning content with human experience and desires that can be implemented with or without indexing subject matter.

The second group, affective-volitional tags 130, capture a possible direct or indirect cognitive, emotional, behavioral, lifestyle, health, personal, professional, or situational effect, desire, goal, or outcome associated with the content. This group may include but is not limited to feelings which the content elicits, or the motivational influence of the content on a particular goal. The third group, content quality tags 140, capture some intrinsic or perceived attribute of the content itself. Such attributes include but are not limited to: any manner or aesthetic or sensory quality of the content such as style, tone, or design element; pragmatic elements of communication such as the presence of satire; rhetorical attributes, such as argumentative style; formal attributes, such as panel discussion or documentary; intentional attributes such as the purpose of the creator; knowledge-level associated with the content, level of refinement, such as how edited or produced is a video clip; originality, such as whether the video clip is entirely original or a composite of existing works; or level of algorithmic influence, such as whether something is human or al generated.

Critically, for a content index 110 to capture and align with the broadest range of human desires and experiences as possible, content must be taggable with the most complete lexicon possible of the individual variations, intensities, and types of the second and third tag groups. Thus, a “tag” hereinafter refers to an individual type, variation, or intensity within either of the two border groups of tags: affective-volitional tags or content quality tags.

Example 1. A user post about an article in a popular science magazine might be labeled with the following tags: inspiring, informative, friendly, inviting, timely, to-the-point, direct. Example 2. A video about celebrity gossip might be tagged with cynical, speculative, uninformative, glib, high-school drama, point form, street talk, casual, heels, Orange County vibe) Example 3. An audio clip is tagged with meditative, relaxing, discussion with friends, idle chat, amateur, develop empathy, find work-life balance, Cape Cod vibe, improvised, cell phone recording.

Tags do not need to be itemized as predefined types. A natural language processing module 200 allows the semantic analysis of both tags and user preferences such that both tags and preferences can be composed of fragmented or whole natural language expressions which are then semantically parsed by the natural language module 200 and matched with one or more natural language matches of the other.

The tagging module 100 operates within the backend server architecture, and its primary function is to facilitate the labeling of content with said affective-volitional 130 and content quality 140 tags. The Tag Database 150 is a specialized section within the general database that stores tag information. Each tag is associated with meta-data detailing its category and type (e.g., category: emotional, type elation), usage statistics, and other relevant information.

The Tag Creation Engine 160 enables users and the system itself to create new tags by defining the tag's attributes and meta-data. The creation can be manual or can be facilitated through natural language processing. The tag Association Engine 170 is responsible for associating tags with content items. This engine fetches relevant tags from the tag database 150 and links them with specific content items stored in the general database. Whenever a tag is used or modified, the Tag Meta-Data Updater 180 updates the meta-data for the tag in the tag database 150.

Whenever a new content item is generated or an existing item is updated, the Tagging Module 100 is triggered. This can be initiated by the user through the User Interface 190 or can be automatically invoked by backend algorithms designed to curate or organize content.

The user may manually select from a list of predefined tags or input natural language descriptions to dynamically create tags. Alternatively, the system's algorithms may auto-generate tags based on the content's characteristics, utilizing the Tag Creation Engine 160. Once tags are selected or created the Tag Association Engine 170 links these tags with the specific content items.

All tagging activities are recorded in the database in real time. The Tag Meta-Data Updater 180 ensures that the tag database 150 is updated whenever a tag is used, created, or modified.

Once tagging has occurred, the content item becomes indexed according to the tags associated with it, thereby enabling more efficient and personalized search and recommendation of the content. The Tagging Module 100 is designed for intuitive user interaction. When a user wishes to tag a content item, the system offers a selection interface where both predefined tags and an option for inputting natural language strings as tags are available. Once the user selects or inputs a description as a tag, the Tagging Module processes this input through the Tag Creation Engine 160 and Tag Association Engine 170 to complete the tagging process.

The Tagging Module 100 interacts heavily with other components of the invention, including but not limited to the Natural Language Processing Module 200 and the Predictive Model 410. For example, tags generated through the Tagging Module 100 are semantically mapped to user preferences by the Natural Language Processing Module 200. Additionally, all content tags 120, 130, 140 serve as input features for the Predictive Model 410, which infers the impact of content on users. The Tagging Module 100, processes the multidimensional tagging of content items, enabling advanced, user-centric content discovery and recommendation functionalities.

The Natural Language Processing (NLP) Module 200 is responsible for the semantic mapping of natural language strings to predefined tags and user preferences. Situated within the backend architecture, this module interfaces with the Tagging Module 100. The components of the NLP Module 200 function as follows:

Natural Language Understanding (NLU) Engine 220 interprets the semantic meaning of natural language inputs from users. It breaks down sentences into tokens, recognizes parts of speech, and identifies entities and sentiments. The Tag Mapper 230 is a specialized algorithm that converts natural language descriptions or sentiments into predefined tags that are stored in the Tag Database 150. The Preference Mapper 240 is another specialized algorithm that associates natural language preferences of users to existing tags or creates new tags.

Working in parallel with the Tag Mapper 230 and Preference Mapper 240, the Semantic Analyzer 250 ensures semantic coherence in the mapping process. The NLP Module 200 is triggered when a user opts to dynamically define and create tags or preferences via natural language strings through the user interface 190. The interface then forwards these inputs to the NLU Engine 220 for initial processing. The NLU Engine 220 breaks down the natural language input into semantic components, identifying essential attributes like sentiment, entities, and action verbs, and aesthetic experiences. This information is then sent to the Tag Mapper 230 or Preference Mapper 240, depending on the nature of the input (tag or preference).

For tag-related inputs, the Tag Mapper 230 identifies the most appropriate predefined tag or sets of tags that semantically correspond to the natural language input. It consults with the Semantic Analyzer 250 to ensure that the mapping is semantically coherent. For preference-related inputs, the Preference Mapper 240 performs a similar function but focuses on mapping the user's expressed preferences to predefined tags. These tags can then be used to filter, search, or recommend content.

Once the appropriate tags have been determined or created, they are sent to the Tagging Module 100 to be associated with the content items. All changes are synchronized in real time, with updates reflected in both the tag database 150 and the general content database.

User interaction with the NLP Module 200 is designed to be straightforward. Users can input natural language strings into provided text fields or dictate via voice recognition. Once input is registered, the NLP Module 200 processes it to generate or map to appropriate tags, thereby personalizing the user's content feed in real-time. The NLP Module 200 works closely with the Tagging Module 100 and Predictive Model 410. Tags generated or mapped by the NLP Module 200 are used by the Tagging Module 100 for content tagging, which is further utilized by the Predictive Model 410 to anticipate user responses.

The User Preferences Module 300 captures and interprets a user's said desires and goals regarding content. This is achieved through natural language inputs, which describe a possible direct or indirect cognitive, emotional, behavioral, lifestyle, wellness, personal, professional, or situational effect, desire, goal, or outcome associated with the content, or any said perceived or intrinsic quality of the content. The components of The User Preferences Module 300 work as follows:

A Natural Language Input Interface 310 is the primary interaction point where users input their preferences using natural language. The Preference Database 320 is a comprehensive repository that stores all user preferences, both predefined and dynamically created, for further mapping and processing, and a Semantic Matching Engine 330, in cooperation with the Natural Language Processing (NLP) Module 200, performs semantic matching 340 between the natural language preferences and the available content tags.

When a user logs into a social media network or media distribution system, they have an option to specify their preferences via the Natural Language Input interface 310. These preferences may consist of any manner of said natural language expressions noted in the foregoing. After the user inputs a natural language preference, the input is forwarded to the NLP Module 200 for preliminary semantic analysis. This analysis converts the natural language into semantically coherent tags or identifiers, which are then stored in the Preference Database 320. Post-storage, these preferences serve as a guide for the Semantic Matching Engine 330, which aligns these stored preferences with tags associated with content. The engine makes use of algorithms to ensure that the matching process is accurate and contextually relevant.

Once a semantic match is confirmed, the content associated with the matched tags is applied to whatever action the user performed, including but not limited to any one of the following: search, filter, feed curation, personalization, or any manner of profile setting. If applied to an ongoing filter or personalization preference, content will continue to be filtered according to the preference match until the user changes the applied preference input. The system is designed to apply these preferences in real time to any content-related activity. This results in a dynamically personalized user experience that is more accurately attuned to the user's desires and goals. The user interacts with the User Preferences feature via a simple and intuitive interface. The user can either type their preferences in a text field or use voice commands, as supported by the Natural Language Input Interface 310. This accessibility ensures that the feature is usable by a broad range of users, including visually impaired users.

A Predictive Model 410 is used to enhance the alignment of user preferences with content, and more specifically, to suggest content that is known to or can be predicted to produce or enable the outcomes either expressed explicitly or implicitly by the user's preferences. It is designed to help predict the impact of content on users with respect to various domains and outcomes, including but not limited to behavioral, emotional, cognitive, personal, professional, situational, and wellness outcomes. It also uses machine learning algorithms and a combination of user feedback and user generated tags to improve predictions over time. Components work with the Predictive Model 410 in the following manner:

The Predictive Model 410 may be trained and implemented in a variety of ways including but not limited to: utilizing pretrained models of human behavior and content influence, a new model may be trained using third-party datasets such that the model is capable of predicting the impact of content on humans, or the model may be trained and implemented using a combination of third party datasets and data generated by the system in the form of user preferences and recorded user feedback and tags. An Outcome Mapping Module 420, maps predicted outcomes to user preferences and content tags.

When the predictive model 410 is trained, either entirely or in part, on data internal to the system, it works as follows: a Data Collection Unit 430 gathers pertinent data related to the content, including the tags created by the Tagging Module 100, as well as human outcome data 460 such as emotional responses or behavioral changes reported by a user. A Feature Extraction Module 440 isolates specific features from this raw data, transforming them into a format that can be fed into the Machine Learning Engine 450. This may involve normalization, transformation, and other data pre-processing techniques. The Machine Learning Engine 450 then uses this processed data to train the predictive model 410. Training algorithms may include but are not limited to neural networks, transformers, deep learning models, recurrent neural networks, optimization algorithms, decision trees, or support vector machines, to refine prediction capabilities.

Once trained, the model predicts potential human outcomes based on content characteristics, preferences, and tags. These outcomes may be as specific as anticipating a user's emotional reaction to a video or as broad as predicting generalized behavioral changes from prolonged content interaction. An Outcome Mapping Module 420 takes predictions and maps them back to content tags and user preferences via the tagging module 100. For example, if the model suggests that a piece of content is likely to produce relaxation in the user, this output is mapped to tags like “Relaxing” or “Calm.”

Users do not interact directly with the Predictive Model 410 but experience its results through more personalized and accurate content matching with user preferences. Their interactions and feedback, however, are crucial data points for refining the model. The system can be configured to refine the predictive model 410 continuously, using the dynamically provided tags by users, user-reported feedback, or other data sources.

The Predictive Model 410 takes input data from both the Tagging Module 100 and the User Preferences Module 300 and generates relevant predictions.

A variety of prediction algorithms may be used in association with a model to generate relevant content-user outcomes or content-tag associations, including but not limited to: nearest neighbour algorithms, cosine similarity, dot product, softmax, or matrix factorization.

The Multidimensional Vector Space Graphical User Interface (GUI) 510 serves as a visual representation of the extensive tag library and the user preference library, offering an interactive method for users to engage with the content and to customize their experiences quickly, intuitively, and effectively. Components work with the Multidimensional Vector Space Graphical User Interface 510 in the following manner: make this refer to 500 fig. shows all components.

A Graphical Display Unit 520 is the primary interface where the multidimensional vector space GUI 510 is displayed. The Tag Cluster Organization Module is Responsible for clustering similar tags within the multidimensional space. Like the Tag Cluster Organization Module 530, a Preference Cluster Organization Module 540 focuses on user preferences. An Input Mechanism 550, such as a mouse, touchpad, touch screen, or any other suitable device, allows the user to interact with the multidimensional vector space GUI 510.

The Graphical Display Unit 520 presents a multidimensional vector space GUI 510 that visually maps existing tags and preferences, which are each stored in their respective digital libraries. For the purposes of this graphical display, tags and preferences may be organized into broad categories of such, clustered according to similarity, with more specific tags and preferences organized as individual tag and preference types 570 within the broader categories. The Tag Cluster Organization Module 540 and Preference Cluster Organization Module 540 organizes tags and preferences into clusters of broad categories leading to more specific individual tag and preference types. This clustering and hierarchical arrangement of tag and preference types within tag categories may be accomplished via various algorithms, such as utilizing vectors with k-means or other nearest neighbour algorithms, hierarchical clustering, cosine similarity, or any manner of systematic organization of data optimized for taxonomic presentation or interactivity. Simultaneously, a Metric Calculation Engine 560 determines the degree of variation within each tag category or preference category and places individual category and preference types along the axes, such that more specific tag and preference types 570 are revealed with increasing distance from the initial point defined by the broader category. This arrangement of categories and types across axes may be rendered in a radial presentation 700, for instance in the manner of a digital graphical color picker wheel, where broader categories of tag and preference types 570 are distributed toward the center, while tag and preference types 570 get more specific within each category toward the perimeter, or increasing orthogonal distance 720 to the center. Variation in broad preference and tag category, such as between moods, goal objectives, and styles may be distributed by azimuth, such that categories vary according to their placement in 365 degrees of radial orientation. For example, a user interested in “Motivational Content” may navigate towards that cluster and further narrow their preference to a specific type of motivation, such as “Self-Improvement” or “Career Growth.”

The Input Mechanism 550 allows the user to navigate through this multidimensional vector space GUI 510, such that users may select individual tags or preferences, across said ranges of variation, thereby associating the selected tags with a content item, or applying the selected preferences to their search, curation, or personalization activities.

Based on user interactions, the system can reorganize or update the multidimensional vector space GUI, thereby improving the menu according to an individual user's preferences over time. Users can also intentionally customize or modify the parameters, clusters, or graphical ordering of the menu such that the categories and type variations are more aligned with their individual usage style and preferences.

Multimedia elements may be used to represent tags or user preferences, and these elements may also be customized. A Multimedia Element Library 620 stores predefined multimedia elements such as images, graphics, symbols, or sounds that can be associated with tags or preferences. A User Multimedia Customization Module 630 enables users to upload, create, or modify multimedia elements to represent tags or preferences. Associating selected or customized multimedia elements with specific tags or preferences is done through a Multimedia-Tag Association Engine 640, and a Multimedia Renderer 650 controls the display of multimedia elements in conjunction with content items within the user interface 190.

Upon the system's first interaction with the user or the loading of a specific user interface 190 view, the Multimedia Renderer 650 fetches appropriate multimedia elements from the Multimedia Element Library 620. These elements are presented alongside content or within menus to symbolize tags or user preferences. Via the user interface 190, users may select from a range of predefined multimedia elements stored in the Multimedia Element Library 620, and these selections are then associated with tags or user preferences through the Multimedia-Tag Association Engine 640.

Users can initiate the User Multimedia Customization Module 630 to upload or create new multimedia elements. This process may involve a multimedia design or editing module that offers various tools to the user, such as graphic design software or audio-editing capabilities. Once the user finalizes the design or selection process, the Multimedia-Tag Association Engine 640 associates the custom-created multimedia elements with specific tags or preferences. All custom multimedia elements are stored in the Multimedia Element Library 620 after their creation. They are now available for the user or other users (based on privacy settings) to access, utilize, or manipulate for any other purpose. Multimedia elements, either predefined or custom-created, can be curated and displayed as collections. These collections may serve various purposes, such as in mood boards, thematic playlists, or educational resources, and thus, content tags with their associated multimedia representations may function as individual items of content that can be shared, organized, arranged, transmitted, or utilized in other activities on a system.

For example: suppose a user, who is an art enthusiast, prefers to search for “Renaissance Paintings.” This user can customize their preference tag with a miniature of the “Mona Lisa” as the multimedia element. Another user who is interested in “Environmental Conservation” might choose a graphical element of a green leaf to represent their tag. And these tags can be aggregated, shared and distributed across the system.

The user interface may offer intuitive design cues to guide users through the customization process. This can include tooltips, step-by-step guides, and previews of how the multimedia elements will appear when associated with tags or preferences. The User Multimedia Customization Module, with other system modules like the Predictive Model 410, can also be integrated into the multidimensional vector space GUI 510, to display multimedia as the user interacts with the multidimensional vector space GUI 510.

Although the current innovation has been illustrated, explained, and defined through specific examples, these examples should not be seen as restrictions on the innovation itself. The innovation is open to significant adjustments, changes, and functional equivalents, as will be apparent to those with standard expertise in the relevant fields. The examples given are merely illustrative and do not cover the full range of the innovation's potential or its possible embodiments. Therefore, the invention is meant to be limited only by the spirit and scope of the accompanying claims, taking into full account functional equivalents in every aspect.

What is claimed is:

1. A computer-implemented method for content indexing, searching, curating, and recommendation, deployed on a social media network or media distribution system, the method comprising:
Labeling items of content with tags that indicate user responses to said content or qualities of said content wherein said tags comprising any one or more of:
emotional mood tags for indicating the emotional mood communicated to users or the mood produced in users;
attitude, tone, or any other pragmatic aspect of communication tags for indicating attitude, tone or any pragmatic aspect of the content;
mode, format, structural, organizational, or technical configuration tags for indicating these attributes;
aesthetic and other sensory interpretations tags, including but not limited to style, design, level of refinement, such as polished or raw, level of originality, and perceived AI influence;
knowledge-level tags for indicating the knowledge-level of the content, the content's author, or any communicator or presenter featured in the content;
intent or purpose tags for indicating the intention or purpose of the content creator in creating the content;
goal-associated effect tags for indicating any content that is known to or can be inferred to have some influence or effect on any manner of human goal, desire, or intention;
behavioral effect tags for indicating whether the content promotes or inhibits a certain user behavior;
cognitive effect tags for indicating whether the content promotes or inhibits a certain cognitive effect;
political presence tags for capturing the extent the content contains any political opinions, language, or political content of any kind;
rhetorical qualities and elements tags for capturing the extent the content contains any rhetorical qualities and elements; and
wherein said content comprises digital or electronic information capable of being distributed or displayed on a social media network or media distribution system comprising any one or more of: written content, post, comment, link, image, video, audio, user, user profile, group, chat, feed, content stream, referenced event, referenced product, referenced object, referenced person, or referenced geographic location; and further including discrete groupings or combinations thereof, such as image boards, playlists, or content collections and;
wherein said content is indexed according to said assigned tags to enable search, curation, filtration, organization, or personalization of said content; and
wherein said content can be searched, filtered, curated, organized, or recommended based on matching user preferences with said tags.

2. The method of claim 1, further comprising an interface configured to enable users to dynamically define and create said tags by inputting natural language strings; wherein said natural language strings indicate said user experiential responses to content or user perceptions of said qualities of said content; wherein said natural language strings being transformed into said tags that are then associated with said content.

3. The method of claim 2, further comprising a natural language processing module configured to semantically map said natural language tags with said user preferences, enabling searching, filtering, curating, organizing, or recommending said content according to said user preferences.

4. The method of claim 1, further comprising an interface configured to receive natural language inputs from users; wherein said natural language inputs define a natural language preference; wherein said natural language preference expresses the user's desired experiential, emotional, cognitive, behavioral, lifestyle, or situational responses to said content, or pragmatic, rhetorical, intentional, formal, or aesthetic qualities of said content; wherein said natural language preference enables searching, filtering, curating, organizing, or recommending said content.

5. The method of claim 4, further comprising a natural language processing module configured to semantically match said natural language preferences to said tags, enabling the searching, filtering, curating, organizing, or recommending said content according to said user preferences.

6. The method of claim 1, further comprising a predictive model configured to enable inferences regarding the impact of content on users; wherein said model utilizing data comprising content characteristics and human outcome data comprising any one or more of behavioral, emotional, cognitive, personal, personality, professional, lifestyle, or wellness data;
wherein said method further comprises mapping model content characteristics to said tags and mapping human outcomes to said preferences;
utilizing outcomes predicted by said model to improve the alignment of said user preferences with said content tags during searching, filtering, curating, organizing, or recommending content.

7. The method of claim 6, wherein said predictive model employs machine learning algorithms to improve said model predictions; wherein data used to improve the model comprises said tags, and any other user reported feedback.

8. The computer-implemented method of claim 1, further comprising: a digital library containing a plurality of existing said content tags;
and wherein the method further comprises displaying, on a graphical user interface, a multidimensional vector space that visually represents said plurality of tags; organizing said plurality of tags within said multidimensional vector space into clusters, wherein each cluster corresponds to said tags; graduating said plurality of tags within each said cluster along at least one axis according to a predetermined metric; wherein said metric measures a degree of variation within the corresponding tag; further specifying that the degree of variation corresponds to individual tag variations or intensities associated with increasingly specific individual tag types; and
wherein said method further comprises enabling a user to interact with said multidimensional vector space using any suitable input mechanism, wherein said interaction allows the user to traverse the multidimensional vector space and select one or more tags from said digital library, thereby associating said selected tags with the content item.

9. The method of claim 1, further comprising a digital library containing a plurality of predefined said user preferences; and
wherein the method further comprises displaying, on a graphical user interface, a multidimensional vector space that visually represents said plurality of predefined user preferences; organizing said plurality of preferences within said multidimensional vector space into clusters, wherein each cluster corresponds to a predefined preference; graduating said plurality of preferences within each said cluster along at least one axis according to a predetermined metric, wherein said metric measures a degree of variation within the corresponding preference; further specifying that the degree of variation corresponds to individual preference variations or intensities associated with increasingly specific individual preferences; and
wherein said method further comprises enabling a user to interact with said multidimensional vector space using any suitable input mechanism, wherein said interaction allows the user to traverse the multidimensional vector space and select one or more preferences from said digital library of preferences, thereby applying the said selected preferences to any search, curation, personalization, filtration, recommendation, or organizational activity engaged by the user.

10. The method of claim 1, further comprising: representing said tags and user preferences by multimedia elements comprising any one or more of images, graphics, symbols, or sounds; wherein said multimedia elements either accompany or substitute a word, phrase, or natural language string describing a tag or preference; and
displaying said multimedia elements in conjunction with said content;
enabling a user to collect, curate, and display collections of said multimedia elements associated with tags or preferences; wherein said multimedia elements function as individual items of content.

11. The method of claim 9, further comprising a graphical user interface that includes an option for a user to create a custom multimedia element when creating a tag; wherein a multimedia design or editing module enables the user to upload, create, or alter multimedia elements to be associated with said tags or preferences; and
wherein said custom-created or altered multimedia elements are associated with a tag or preference upon completion of the design or editing process; and
said associated custom multimedia elements are stored within a digital library to be accessed, utilized, or manipulated by any user for any other purpose.
